(19) United States
(12) Patent Application Publication
(10) Pub. No.: US 2016/0323379 A1
(43) Pub. Date: Nov. 3, 2016

(54) DISTRIBUTED STORAGE OF SOFTWARE IMAGES IN COMPUTING SYSTEMS

(71) Applicant: Microsoft Technology Licensing, LLC, Redmond, WA (US)

(72) Inventors: Vaishnav Kidambi, Redmond, WA (US); Chacko Daniel, Redmond, WA (US); Vipul Modi, Sammamish, WA (US); Alex Wun, Renton, WA (US)

(21) Appl. No.: 14/750,974

(22) Filed: Jun. 25, 2015

Related U.S. Application Data
(60) Provisional application No. 62/153,917, filed on Apr. 28, 2015.

(51) Int. Cl. H04L 29/08

(52) U.S. Cl. CPC H04L 67/1095; H04L 67/1097; H04L 67/34

(57) ABSTRACT

Various techniques for distributed storage of images of software application in a computing fabric are disclosed herein. In one embodiment, a method includes receiving a request to upload and store a software application in a computing fabric having a plurality of nodes individually configured to execute the software application. A first copy of the uploaded software application is then received and stored at a first node of the computing fabric. The method also includes replicating the first copy as additional copies at one or more additional nodes of the computing fabric via the communications network. As such, multiple copies of the software application can be stored in the computing fabric without utilizing an external repository.

### CROSS-REFERENCE TO RELATED APPLICATION(S)

This application is a non-provisional of and claims priority to U.S. Provisional Application No. 62/153,917, filed on Apr. 28, 2015.

### BACKGROUND

Cloud computing typically utilizes a collection of virtual machines or other remote servers, rather than local servers or personal computers, to process, manage, or store user data. A communications network typically interconnects the remote servers as nodes in a “weave” configuration to form a computing fabric. One or more nodes of the computing fabric can cooperate with one another to provide a computing environment that facilitates execution of various software applications for delivering cloud computing services.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

During operation of a computing fabric, interconnected nodes can provide a computing environment for executing various software applications. For example, one or more nodes can execute software applications designed for banking, e-commerce, content delivery, online gaming, and/or other suitable cloud computing services. Typically, the various nodes of the computing fabric rely upon a repository external to the nodes for storing “golden” images of software applications. However, such an arrangement can be inefficient and unreliable. For instance, the external image repository may be unavailable due to service failures or other causes. Even if the external image repository is available, the nodes may experience latency issues and/or difficulties in retrieving images of the software applications due to network slowdowns or failures.

Several embodiments of the disclosed technology can address at least some of the foregoing difficulties by implementing distributed storage of images of software applications in at least some nodes in a computing fabric. As such, the need for an external repository can be eliminated. In one implementation, a number of nodes in a computing fabric can individually store an identical image or copy of a software application. Among these nodes, one can be designated or elected as a primary node, and the other nodes can be designated as secondary nodes. The primary node can generate and store tracking information or metadata that tracks the stored images of the software application. The metadata can include, for example, file names, file sizes, versions, creation date, upload date, storage node ID, download history, and/or other suitable information.

When a request is received for a copy of the stored image, in certain embodiments, the primary node can simply provide the stored metadata associated with the stored image to a requestor. The requestor can then determine one or more available nodes/locations from which a copy of the stored image may be retrieved. In other embodiments, the primary node can instead make such a determination based on information in the metadata and supply the determined node/location information to the requestor. Because multiple copies of the image are stored in a distributed fashion at different nodes of the computing fabric, a copy of the requested image can be retrieved even when one or more nodes become unavailable. Thus, the distributed storage of images can be highly available, fault tolerant, and scalable. In addition, close proximity between the nodes of the computing fabric and the stored images can also reduce latency when compared to accessing an external repository.

### BRIEF DESCRIPTION OF THE DRAWINGS

FIGS. 1-4 are schematic diagrams illustrating a computing framework having a computing fabric with distributed storage of application images in accordance with embodiments of the disclosed technology.

FIG. 5 is a block diagram showing software modules suitable for the primary node of FIGS. 1, 2, and 3 and in accordance with embodiments of the disclosed technology.

FIGS. 6A and 6B are flow diagrams illustrating embodiments of a process of upload and download an application image to/from a computing fabric, respectively, in accordance with embodiments of the disclosed technology.

FIG. 7 is an example data schema suitable for the metadata of FIGS. 1-4 in accordance with embodiments of the disclosed technology.

FIG. 8 is a computing device suitable for certain components of the computing framework in FIG. 1.

### DETAILED DESCRIPTION

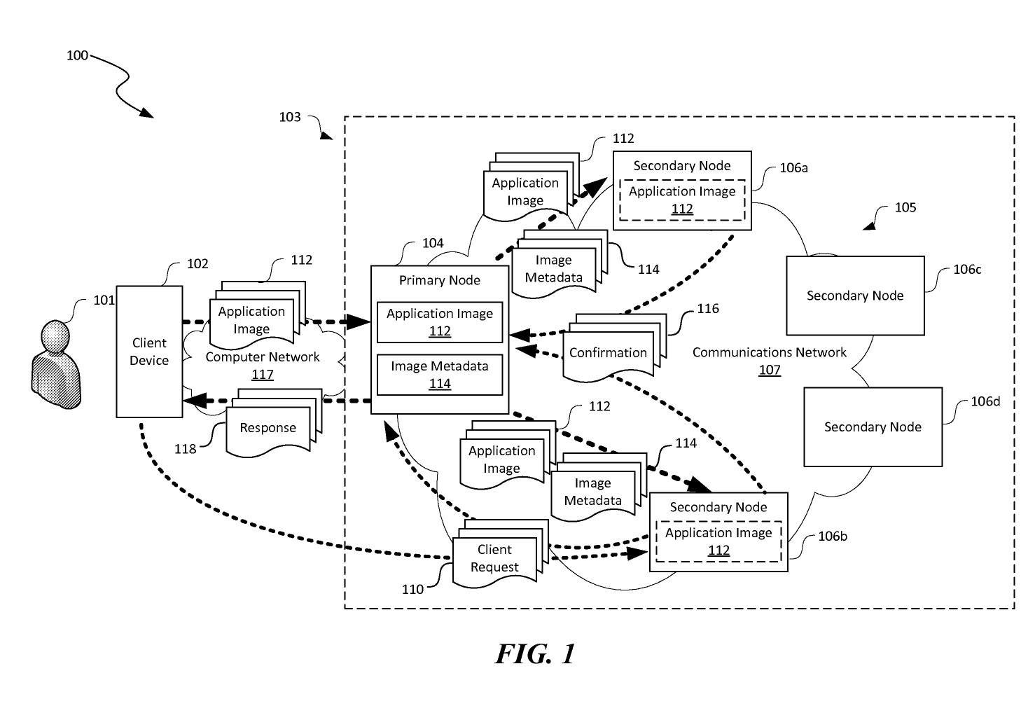

Certain embodiments of systems, devices, components, modules, routines, and processes for distributed storage of application images in a computing fabric are described below. In the following description, specific details of components are included to provide a thorough understanding of certain embodiments of the disclosed technology. A person skilled in the relevant art will also understand that the disclosed technology may have additional embodiments or may be practiced without several of the details of the embodiments described below with reference to FIGS. 1-8.

As used herein, the term “computing fabric” generally refers to a computing system having a plurality of nodes interconnected by a communications network in a “weave” or other suitable configurations. A “node” in a computing fabric generally refers to a computing element. In certain embodiments, a computing element can include a physical server with one or more computing processors, memory devices, and/or peripherals. In other embodiments, a computer element can include a system, application, or other suitable types of virtual machine with virtualized processor, memory, and/or storage devices. Nodes of a computing fabric can be interconnected by a physical computer network and/or one or more virtual computer networks.

Also used herein, a “software application” generally refers to one or more programs configured to perform a set of coordinated functions, tasks, or activities. Example software applications can include those designed for banking, e-commerce, content delivery, online gaming, and/or other suitable computing services. Also used herein, the term “image” generally refers to a digital copy of a piece of computer software, for example, a software application or a portion thereof.

FIG. 1 is a schematic diagram illustrating a computing framework 100 having a computing fabric with distributed storage of application images during an upload operation in accordance with embodiments of the disclosed technology. As shown in FIG. 1, the computing framework 100 can include a client device 102 and a computing fabric 103 interconnected by a computer network 117. The client device 102 can include a desktop, a laptop, a tablet, a smartphone, and/or other suitable types of computing device. The computer network 117 can include the Internet, a local area network, a metropolitan area network, a wide area network, and/or other suitable types of network. Even though various embodiments of the technology are described below with reference to images of software applications, in other embodiments, similar techniques may also be implemented for distributed storage of user data, enterprise data, and/or other suitable types of digital data organized into files, directories, subdirectories, etc.

As shown in FIG. 1, the computing fabric 103 can include a plurality of nodes 105 interconnected by a communications network 107. In certain embodiments, the nodes 105 can be interconnected in a weave configuration. In other embodiments, the nodes 105 can be interconnected in a ring, a star, or other suitable types of configuration. In FIG. 1, five nodes 105 (i.e., a primary node 104 and four secondary nodes 106a, 106b, 106c, and 106d) are shown. In other embodiments, the computing fabric 103 can also include two, three, four, six, or any other suitable number of nodes 105.

The communications network 107 can include any suitable types of network. For example, in one embodiment, the communications network 107 can include an Ethernet or Fast Ethernet network having routers, switches, load balancers, firewalls, and/or other suitable network components. In other embodiments, the communications network 107 can also include an InfiniBand network with corresponding network components. In further embodiments, the communications network 107 can also include a combination of the foregoing and/or other suitable types of computer networks.

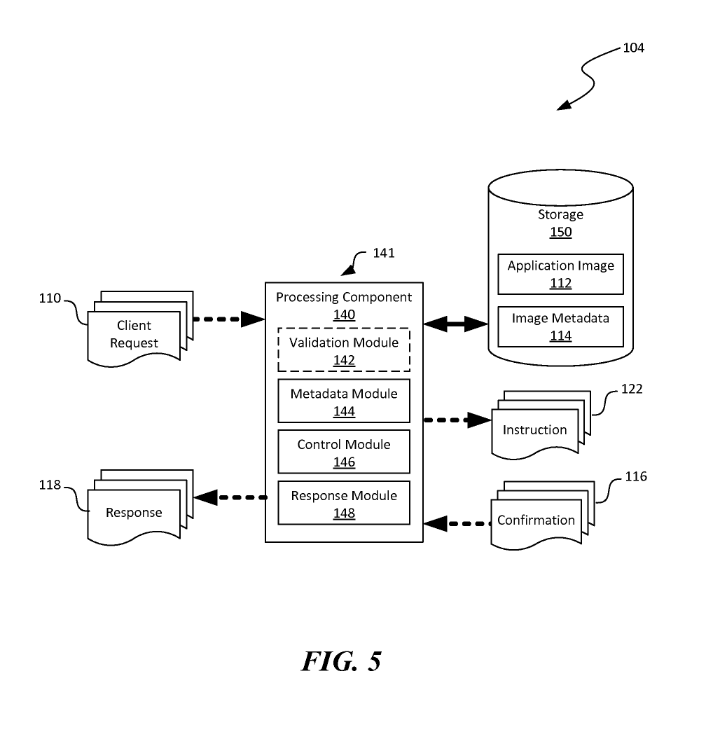

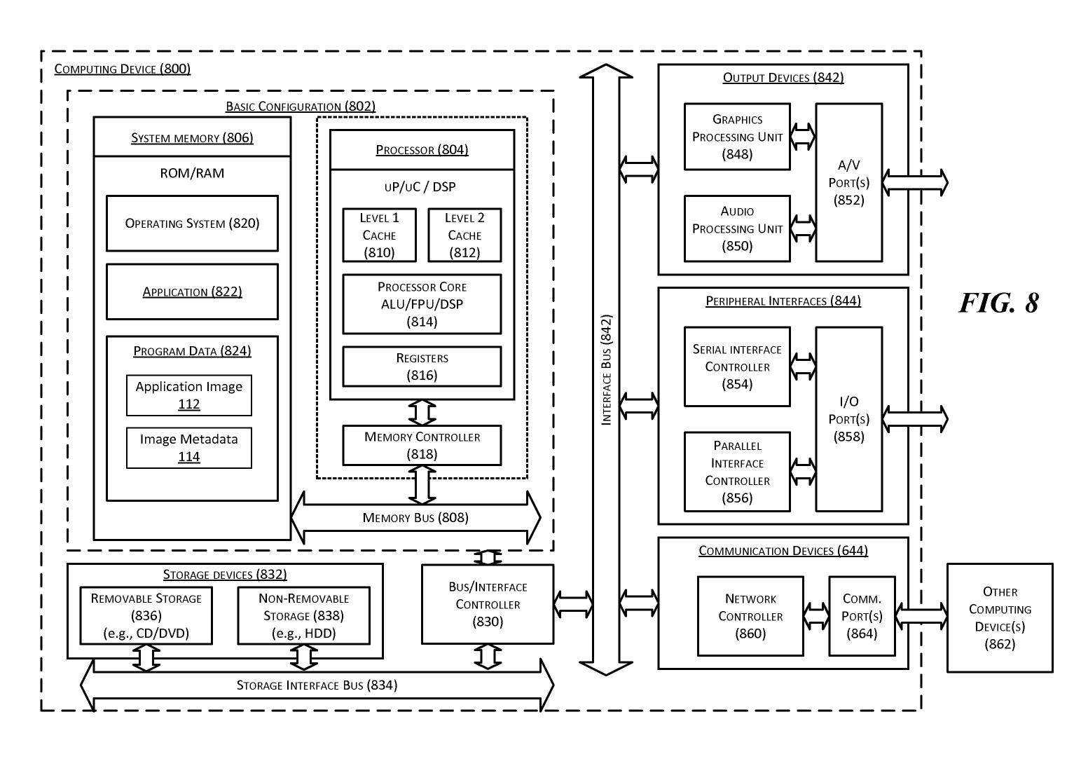

The individual nodes 105 can include a physical server or a virtual machine hosted on a physical server. As such, the individual nodes 105 can include one or more physical and/or emulated processors and memory devices that contain instructions for execution by the one or more processors to provide certain software components discussed in more detail below with reference to FIG. 5-7. The physical server can be any suitable types of computing device. One example is described below with reference to FIG. 8. In any of the embodiments described herein, each of the nodes 105 in the computing fabric 103 can include one or more components (e.g., processors or emulated processors) configured to execute a software application corresponding to the application image 112 stored therein. For example, the primary node 104 (or any one of the first or second secondary node 106a or 106b) can be configured to load the application image 112 into a memory for execution, and provide execution results to an application client (not shown) that requests the execution.

In the illustrated embodiment, the nodes 105 are designated as a primary node 104 and first, second, third, and fourth secondary nodes 106a-106d, respectively. Such designations are for convenience of description. In certain embodiments, the primary node 104 and the secondary nodes 106a-106d can be generally similar in components and functions. In other embodiments, the primary node 104 and the secondary nodes 106a-106d can have different configurations, components, and/or functions. In one embodiment, the primary node 104 is designed by an administrator (e.g., a user 101) via the client device 102. In another embodiment, the nodes 105 can elect one of the nodes 105 to be the primary node 104. In further embodiments, more than one of the nodes 105 may be designated, elected, or otherwise identified as the primary node(s) 104 configured for failover and/or other suitable backup purposes.

The primary node 104 can be configured to facilitate distributed storage of copies of application images 112 in the computing fabric 103, and thus eliminate the need for an external repository. Example upload, download, and deletion operations for the application image 112 in the computing fabric 103 are described below with reference to FIGS. 1-3, respectively. In other embodiments, the primary node 104 and/or other components of the computing fabric 103 can also be configured to respond to image presence, image list, and/or other suitable types of inquiries.

### Upload

During an upload operation, the primary node 104 can initially receive a client request 110 from the client device 102 to upload an application image 112. In the illustrated embodiment, the second secondary node 106b first receives the client request 110 and forwards it to the primary node 104. In other embodiments, the client device 102 can transmit the client request 110 directly to the primary node 104 or via one of the other secondary nodes 106a, 106c, or 106d.

In response to receiving client request 110, the primary node 104 can generate and store a record of image metadata 114 associated with the application image 112. The image metadata 114 can include a file name, file size, version, creation date, upload date, storage node ID, download history, and/or other suitable information. The primary node 104 can obtain at least one of the foregoing parameters from the client request 110 and can also assign at least one of the foregoing parameters by itself. For example, the primary node 104 can assign a version, an upload date, or other suitable information for the application image 112. The primary node 104 can then receive the application image 112 from the client device 102 via the computer network 117 according HTTP, FTP, or other suitable protocols. Even though the request 110 and the application image 112 are shown in FIG. 1 as separate entities, in other embodiments, the request 110 and the application image 112 may be combined into a single entity.

Upon receiving the application image 112, the primary node 104 can store a copy of the application image 112 along with associated image metadata 114 locally, for example, in a physical and/or emulated storage device (not shown). The primary node 104 can also transmit a copy of the associated image metadata 114 to one or more secondary nodes 106a-106d. In certain embodiments, the primary node 104 can select the one or more of the secondary nodes 106a-106d randomly, based on a proximity of physical or logical locations of the nodes 105, based on a storage capacity of the nodes 105, or based on other suitable conditions. In other embodiments, the primary node 104 does not select the secondary nodes 106a-106d, but instead transmits a copy of the image metadata 114 to every secondary node 106a-106d.

In FIG. 1, the primary node 104 selects the first and second secondary nodes 106a and 106b to receive the image metadata 114 for illustration purposes. In other examples, the primary node 104 can select additional and/or different secondary nodes 106a-106d. Upon receiving the image metadata 114, the first and second secondary nodes 106a and 106b can each request a copy of the application image 112 from the primary node 104 or other secondary nodes 106a-106d that already have a copy of the application image 112 using server message blocks or other suitable file transfer channels. Once file transfers are completed, the application image 112 is replicated on the first and second secondary nodes 106a and 106b (shown in phantom lines for clarity). The first and second secondary nodes 106a and 106b can also transmit confirmations 116 to the primary node 104 indicating completion of the file transfers.

Based on the received confirmations 116, the primary node 104 can then update the image metadata 114 associated with the application image with, for example, storage ID(s) indicating nodes 105 at which a copy of the application image 112 is stored. In the illustrated example, the storage IDs can include IDs associated with the primary node 104 and the first and second secondary nodes 106a and 106b. The primary node 104 can also update the upload date, version, and/or other information associated with the application image 112.

The primary node 104 can also be configured to generate a response 118 indicating to the client device 102 that the requested upload is completed. In one embodiment, the primary node 104 can indicate upload completion when the confirmations 116 are received from more than 10%, 20%, 30%, 40%, 50%, or any other suitable value of the nodes 105. In other embodiments, the primary node 104 can indicate upload completion when the confirmations 116 are received from a target number (e.g., 5) of the nodes 105. In further embodiments, the primary node 104 can indicate upload completion based on other suitable criteria.

### Download

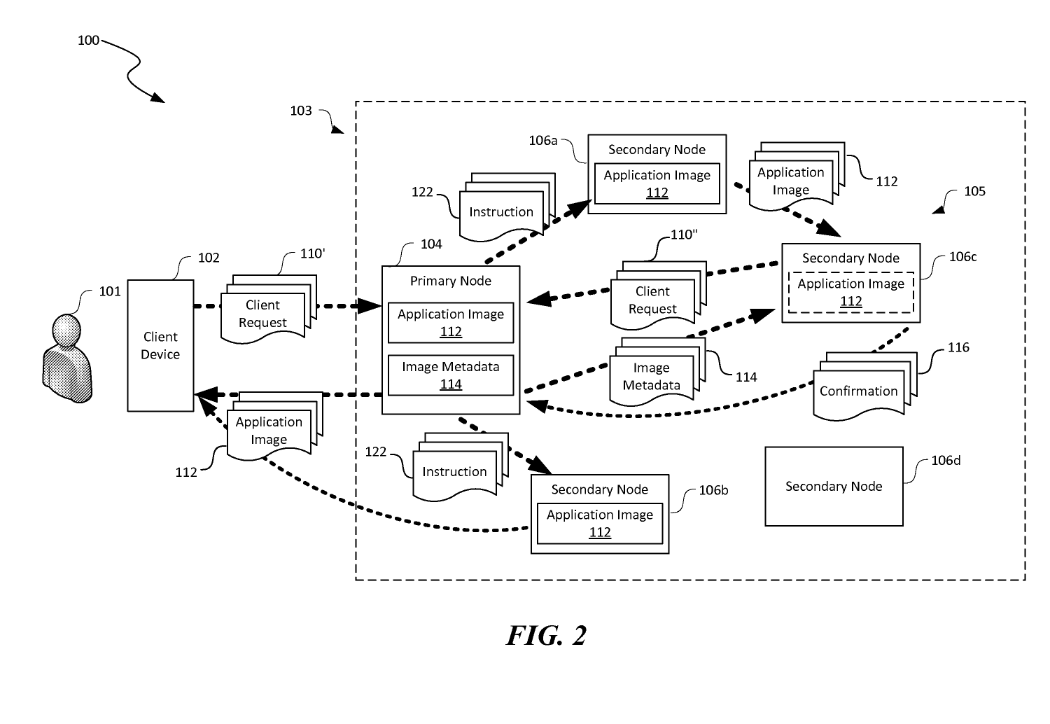

FIG. 2 illustrates a download operation for the computing fabric 103 in accordance with embodiments of the disclosed technology. In FIG. 2 and other figures hereafter, the computer network 117 and communications network 107 are omitted for clarity. As shown in FIG. 2, the client device 102 can transmit another client request 110′ requesting to download a copy of the application image 112 stored in the computing fabric 103. In the illustrated embodiment, the client device 102 transmits the client request 110′ to the primary node 104 directly. In other embodiments, the client device 102 can also transmit the client request 110′ to one of the other nodes 105, which in turn can forward the client request 110′ to the primary node 104.

In response to the received client request 110′, the primary node 104 can determine available node(s) 105 at which a copy of the application image 112 is stored or is available. In certain embodiments, the primary node 104 can determine the available node(s) 105 based on information contained the stored image metadata 114 (e.g., the storage ID(s)). In other embodiments, the primary node 104 can also determine the available node(s) 105 based on a current status of the secondary nodes 106a-106d (e.g., online, offline, failure, alarm, etc.), a current traffic condition of the communications network 117 (FIG. 1), or based on other suitable parameters.

As shown in FIG. 2, in one embodiment, the primary node 104 determines that itself is available to transmit a copy of the stored application image 104 to the client device 102. In response to the determination, the primary node 104 can transmit a copy of the application image 112 stored in itself to the client device 102 via the computer network 107 (FIG. 1). In other embodiments, the primary node 104 can also determine that one of the secondary nodes 106a-106d is available to transmit the stored application image 112. In response to the determination, the primary node 104 can transmit an instruction 122 to, for example, the second secondary node 106b to transmit a copy of the application image 112 stored in the second secondary node 106b to the client device 102. In further embodiments, the primary node 104 can provide the image metadata 114 and available nodes 105 for the requested application image 112 to the client device 102. In turn, the client device 102 can determine from which one of the nodes 105 to download a copy of the stored application image 112.

The primary node 104 can also be configured to provide a copy of the stored application image 112 to one of the nodes 105 in the computing fabric 103. For example, as illustrated in FIG. 2, the third secondary node 106c can transmit a client request 110″ to the primary node 104 requesting a copy of the application image 112. In one embodiment, the primary node 104 can select one of the nodes 105 from which the third secondary node 106c can retrieve a copy of the application image 112 based on information contained in the image metadata 114. In certain embodiments, the primary node 104 can select one of the nodes 105 that is physically, logically, and/or in other ways closes to the third secondary node 106c. In other embodiments, the primary node 104 can select one of the nodes 105 randomly, sequentially, or in other suitable orders.

In further embodiments, the primary node 104 can select one of the nodes 105 based on at least one of availability, online status, network traffic condition, maintenance schedule, and/or other suitable parameters of the nodes 105 storing a copy of the application image 112. The primary node 104 (or other suitable network components, not shown) can obtain such information by, for example, periodically polling the one or more nodes 105 and store the obtained information in, for example, the image metadata 114. In other examples, the primary node 104 can also receive such information via the confirmation 116. In yet further embodiments, the primary node 104 can select one of the nodes 105 based on a combination of the foregoing and/or other suitable parameters. Upon selecting one of the nodes 105 (e.g., the second secondary node 106b in FIG. 2), the primary node 104 can transmit an instruction 122 to the selected node 105 to initiate the file transfer as shown in FIG. 2.

In further embodiments, the primary node 104 can also inform the third secondary node 106c of the selection. In yet further embodiments, the primary node 104 can simply provide the image metadata 114 to the third secondary node 106c without selecting one of the nodes 105. Instead, the third secondary node 106c can select one of the nodes 105 based on information contained in the image metadata 114. The third secondary node 106c can then obtain a copy of the application image 112 from the second secondary node 106b. Once the file transfer is completed, the third secondary node 106c can transmit a confirmation 116 to the primary node 104 indicating accordingly. In response to the received confirmation 116, the primary node 104 can update the image metadata 114 indicating that a copy of the application image 112 is now also available on the third secondary node 106c as well.

### Deletion

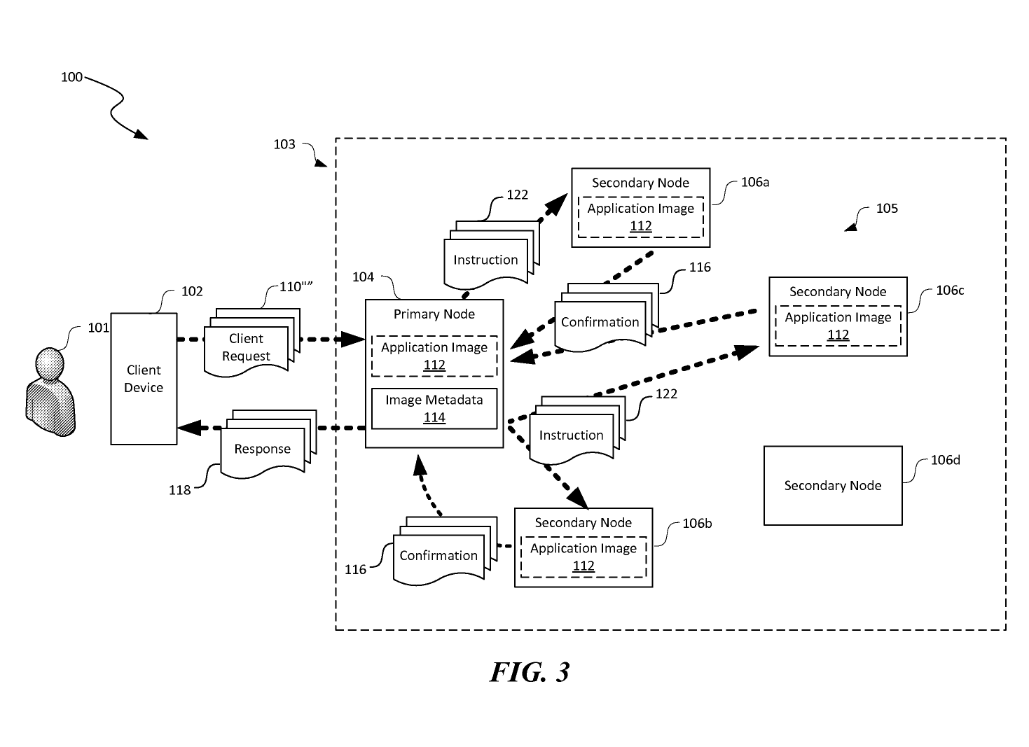

FIG. 3 illustrates a deletion operation for the computing fabric 103 in accordance with embodiments of the disclosed technology. As shown in FIG. 3, the user 101 can transmit another client request 110″″ indicating a request to delete the stored application image 112 in the computing fabric 103. In response, in certain embodiments, the primary node 104 deletes the copy of the application image 112 stored thereon. The primary node 104 can also determine which other nodes 105 also contain a copy of the application image 112. In the illustrated embodiment, the first, second, and third secondary nodes 106a, 106b, and 106c all contain a copy of the application image 112. Based on the determination, the primary node 104 can transmit an instruction 122 to each of the first, second, and third secondary nodes 106a-106c to delete the copies of the application image 112 stored thereon. Once deletion is completed, the first, second, and third secondary nodes 106a-106c can each transmit a confirmation 116 to the primary node 104 indicating accordingly. Based on the received confirmations 116, the primary node 104 can then generate a response 118 to the client device 102 based on criteria associated with a percentage or number of received confirmations 116, as described above with reference to FIG. 1. In other embodiments, the primary node 104 can transmit the instruction to delete to all of the secondary nodes 106a-106d. Once the primary node 104 receives a confirmation 116 from, for example, a majority of the secondary nodes 106a-106d confirming deletion of the application image 112, the primary node 104 can delete its own local copy of the application image 112 and generates the response 118 to the client device 102.

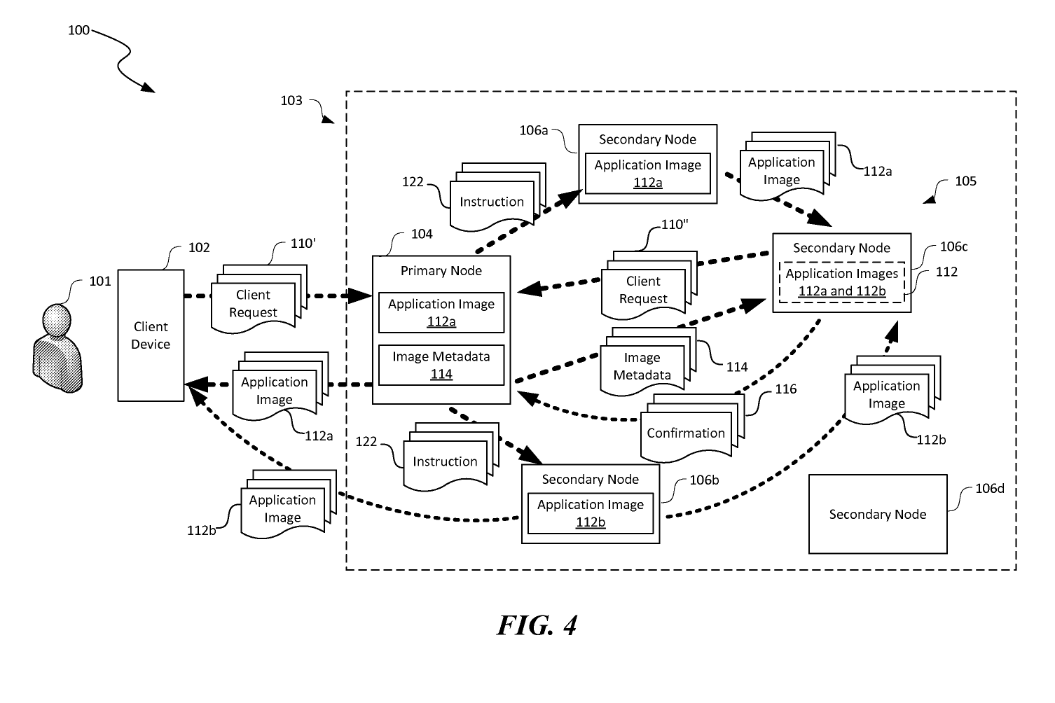

Embodiments of the computing fabric 103 described above with reference to FIGS. 1-3 are directed to distributed storage of identical copies of the application image 112 at individual nodes 105. However, other embodiments of the computing fabric 103 can also be configured for distributed storage of segments, parts, fragments, or portions of the application image 112. For example, as illustrated in FIG. 4, the application image 112 can be divided into a first portion 112a and a second portion 112b. In certain embodiments, the primary node 104 can be configured to apportion the uploaded application image 112 (FIG. 1). In other embodiments, the uploaded application image 112 may be apportioned, for example, by the client device 102, prior to being uploaded. In further embodiments, other suitable entities can divide the application image 112 into three, four, or any suitable number of portions.

In operation, the primary node 104 can be configured to select one or more secondary nodes 106a-106b for storing at least one portion of the uploaded application image 112. The selection criteria can be generally similar to those described above with reference to FIG. 1. In the illustrated example in FIG. 4, the primary node 104 selects itself and the first secondary node 106a to each store a copy of the first portion 112a, and selects the second secondary node 106b to store a copy of the second portion 112b. In other examples, additional and/or different secondary nodes 106a-106d may be selected to store a copy of the first or second portion 112a and 112b.

The primary node 104 can further be configured to generate and store the image metadata 114 that tracks storage locations/nodes containing different portions of the application image 112. When a client request 110 is received for a copy of the application image 112, in one embodiment, the primary node 104 can determine one or more suitable nodes 105 from which the different portions 112a and 112b may be retrieved. For example, as shown in FIG. 4, in response to the client request 110′ from the client device 102, the primary node 104 can determine that itself is available for transmitting the first portion 112a, and that the second secondary node 112b is available to transmit the second portion 112b. Then, the primary node 104 can transmit the first portion 112a from itself to the client device 102. The primary node 104 can also transmit an instruction 122 to the second secondary node 106b to transmit the second portion 112b to the client device 102. The client device 102 can then assemble the first and second portions 112a and 112b into a complete copy of the application image 112.

In another example, the third secondary node 106c can transmit a client request 110″ to the primary node 104 for a complete copy of the application image 112. In response to the received client request 110″, the primary node 104 can determine that a copy of the first portion 112a is available from the first secondary node 106a, and that a copy of the second portion 112b is available from the second secondary node 106b. The primary node 104 can then transmit instructions 122 to each of the first and second secondary nodes 106a and 106b to transfer a copy of the stored first and second portions 112a and 112b to the third secondary node 106c, respectively.

Upon completion of the transfer, the third secondary node 106c can assemble a complete copy of the application image 112 from the first and second portions 112a and 112b. The third secondary node 106c can then transmit a confirmation 116 to the primary node 104 indicating accordingly. The primary node 104 can then update the image metadata 114 to indicate that a copy of both the first and second portions 112a and 112b are stored on the third secondary node 106c. In further embodiments, the primary node 104 can simply provide node/location availability information of the first and second portions 112a and 112b to the third secondary node 106c. In turn, the third secondary node 106c can determine from which node/location to retrieve a copy of the first and second portions 112a and 112b based on at least one of a proximity, network traffic condition, node/network load condition, and/or other suitable criteria.

Several embodiments of the computing fabric 103 can have highly available, fault tolerant, and scalable distributed storage of the application image 112. Because multiple copies of the application image 112 are stored in a distributed fashion at different nodes 105, one copy of the application image 112 can be available even when one or more of the nodes 105 fail or otherwise become unavailable. For example, referring to FIG. 2, even when the first and second secondary nodes 106a and 106b become unavailable, a copy of the application image 112 is still available at the primary node 104 in response to the client request 110 from the client device 102 or the third secondary node 106c. In another example, when the primary node 104 becomes unavailable, one of the secondary nodes 106a-106d can be designated, elected, and/or otherwise determined to be a new primary node, which contains all the image metadata 114 from the previous primary node 104.

Even though the computing framework 100 is described above as having particular components, the computing framework 100 can include additional and/or different hardware/software components than those in FIGS. 1-4. For example, in some embodiments, the computing fabric 103 can also include a fabric controller (not shown) configured in a kernel of an operating system for the computing fabric. In other embodiments, the computing fabric 103 can also include fabric interconnects, fabric extenders, and/or other suitable components.

In other embodiments, components of the computing fabric 103 may also be configured to perform additional and/or different operations. For example, in certain embodiments, the primary node 104 can be configured to validate a received client request 110 before performing an upload, download, deletion, or other operation. In other examples, the primary node 104 can also be configured to check if a particular application image 112 is stored in the computing fabric 103, or to list all application images 112 stored in the computing fabric 103 in response to a client request 110.

In any of the foregoing embodiments described above, upload, download, deletion, and other suitable types of operations can also be implemented as uninterruptible or commonly referred to as “atomic” operations. For example, during the upload operation described above with reference to FIG. 1, the primary node 104 (or other suitable components of the computing fabric 103) may preclude download, deletion, or other types of operations being performed on the application image 112 or a directory of multiple application images (not shown) being uploaded until the primary node 104 determines that the upload is completed.

FIG. 5 is a block diagram showing software modules 141 suitable for the primary node 104 of FIGS. 1-4 and in accordance with embodiments of the disclosed technology. In FIG. 5 and in other Figures hereinafter, individual software components, objects, classes, modules, and routines may be a computer program, procedure, or process written as source code in C, C++, Java, and/or other suitable programming languages. A component may include, without limitation, one or more modules, objects, classes, routines, properties, processes, threads, executables, libraries, or other components. Components may be in source or binary form. Components may include aspects of source code before compilation (e.g., classes, properties, procedures, routines), compiled binary units (e.g., libraries, executables), or artifacts instantiated and used at runtime (e.g., objects, processes, threads).

Components within a system may take different forms within the system. As one example, a system comprising a first component, a second component and a third component can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a network server, a laptop computer, a smartphone, and/or other suitable computing devices. Various implementations of the source, intermediate, and/or object code and associated data may be stored in a computer memory that includes read-only memory, random-access memory, magnetic disk storage media, optical storage media, flash memory devices, and/or other suitable computer readable storage media excluding propagated signals.

As shown in FIG. 5, the primary node 104 can include a processing component 140 coupled to a storage 150. The storage 150 can be configured to store the application image 112, the image metadata 114, and/or other suitable data. The processing component 140 can include a plurality of software modules 141 configured to facilitate distributed storage of the application image 112 in the computing fabric 103 (FIG. 1).

The software modules 141 can include an optional validation module 142, a metadata module 144, a control module 146, and a response module 148 operatively coupled to one another. In one embodiment, all of the software modules 141 can reside on a single computing device (e.g., a network server). In other embodiments, the software modules 141 can also reside on a plurality of distinct computing devices. In further embodiments, the software modules 141 may also include interface modules, input/output modules, and/or other suitable modules (not shown). The optional validation module 142 can be configured to validate any received client request 110 based on a security credential, a IP address from which the client request 110 is received, or other suitable conditions. The metadata module 144 can be configured to generate, update, and store the image metadata 114 associated with the application image 112 in the storage 150, as described in more detail above with reference to FIG. 1.

The control module 146 can be configured to perform requested operations based on the received client request 110. For example, in one embodiment, if the received client request 110 indicates that an upload operation is requested, the control module 146 can be configured to receive and store the application image 112 in the storage 150, as described in more detail above with reference to FIG. 1. In other embodiments, the control module 146 can also be configured to download or deletion, as described above with reference to FIGS. 2 and 3. In further embodiments, the control module 146 can be configured to perform other suitable operations.

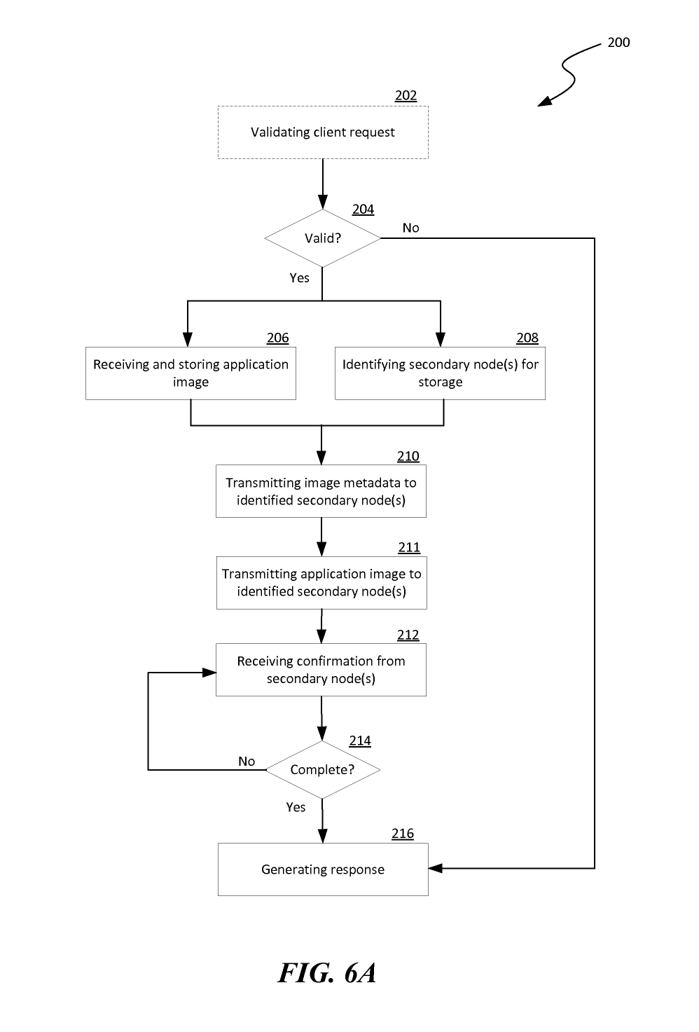

The response module 148 can be configured to generate and transmit a response 118 to the client device 102 (FIG. 1). For example, in one embodiment, the response module 148 can be configured to generate a response 118 indicating a success, failure, error, or other suitable status of the requested operation. In other embodiments, the control module 146 can also be configured to instruct the response module 148 to generate and transmit one or more instructions 122 to select secondary nodes 106a-106d (FIG. 1) for performing various operations. In further embodiments, the control module 146 can also be configured to receive confirmations 116 from one or more of the secondary nodes 106a-106d. Example operations of the software modules 141 are described in more detail below with reference to FIGS. 6A and 6B.

FIG. 6A is a flow diagram illustrating embodiments of a process 200 of uploading an application image to a computing fabric with distributed storage for application images in accordance with embodiments of the disclosed technology. Even though various embodiments of the process 200 are described below with reference to the computing framework 100 of FIGS. 1-4 and the software modules 141 of FIG. 5, in other embodiments, the process 200 may be performed with other suitable types of computing frameworks, systems, components, or modules.

As shown in FIG. 6A, the process 200 can include an optional stage 202 at which a client request received from a client device 102 (FIG. 1) is validated by, for example, the primary node 104 of FIG. 1. Validation may be performed by the validation module 142 in FIG. 5 and based on a security credential, a password, a passcode, and/or other suitable criteria. The process 200 can then include a decision stage 204 to determine if the client request is valid. In response to determining that the client request is invalid, the process 200 proceeds to generating a response indicating that the requested operation cannot be performed at stage 216.

In response to determining that the client request is valid, the process 200 proceeds to receiving the application image from the client device 102 and storing the application image at, for example, the primary node 104 at stage 206. The process 200 also includes another stage 208 at which one or more secondary nodes 106a-106d (FIG. 1) are identified to store a copy of the received application image. Various criteria may be used to identify the one or more secondary nodes 106a-106d, as described in more detail above with reference to FIG. 1. Even though stages 206 and 208 are shown in FIG. 6A as being concurrent to each other, in other embodiments, operations of stages 206 and 208 can also be performed sequentially with or without overlapping.

The process 200 can then include transmitting, for example, from the primary node 104, image metadata associated with the received application image and/or the application image to the identified one or more secondary nodes 106a-106d at stage 210 and 211, respectively. Even though stages 210 and 211 are shown in FIG. 6A as being sequential to each other, in other embodiments, operations of stages 210 and 211 can also be performed concurrently or can be at least partially overlapping. In further embodiments, transmitting the metadata at stage 210 may be omitted. Instead, the primary node 104 can directly transmit a copy of the application image to the identified one or more secondary nodes 106a-106d.

The process 200 can then include receiving confirmation(s) from the one or more secondary node 106a-106d at stage 212. The process 200 can then include a decision stage 214 to determine if the upload operation is completed successfully. Various criteria for such a determination are described in more detail above with reference to FIG. 1. In response to determining that the upload operation is completed successfully, the process 200 includes generating a response indicating accordingly to the client device 102; otherwise, the process 200 reverts to receiving confirmation(s) from the secondary node(s) 106a-106d at stage 212.

FIG. 6B is a flow diagram illustrating certain embodiments of a process 220 of retrieving an application image from a computing fabric with distributed storage for application images in accordance with embodiments of the disclosed technology. Though not shown in FIG. 6B for clarity, in certain embodiments, the process 220 can also include the optional validation stages 202 and 204.

As shown in FIG. 6B, the process 220 can include determining one or more node(s) or location(s) at which a copy of an application image is available at stage 222. Various criteria for determining such availability are described above with reference to FIG. 2. The process 220 can then include a decision stage 224 to determine if at least one copy of the application image is available. In response to determining that not even one copy of the application image is available, the process 220 includes generating a response indicating that the requested operation cannot be completed at stage 216. In response to determining that at least one copy of the application image is available, in one embodiment, the process 220 includes transmitting the identified node(s)/location(s) to a requestor (e.g., the third secondary node 106c of FIG. 2) at stage 226. Based on the transmitted information, the requestor may then retrieve a copy of the stored application image.

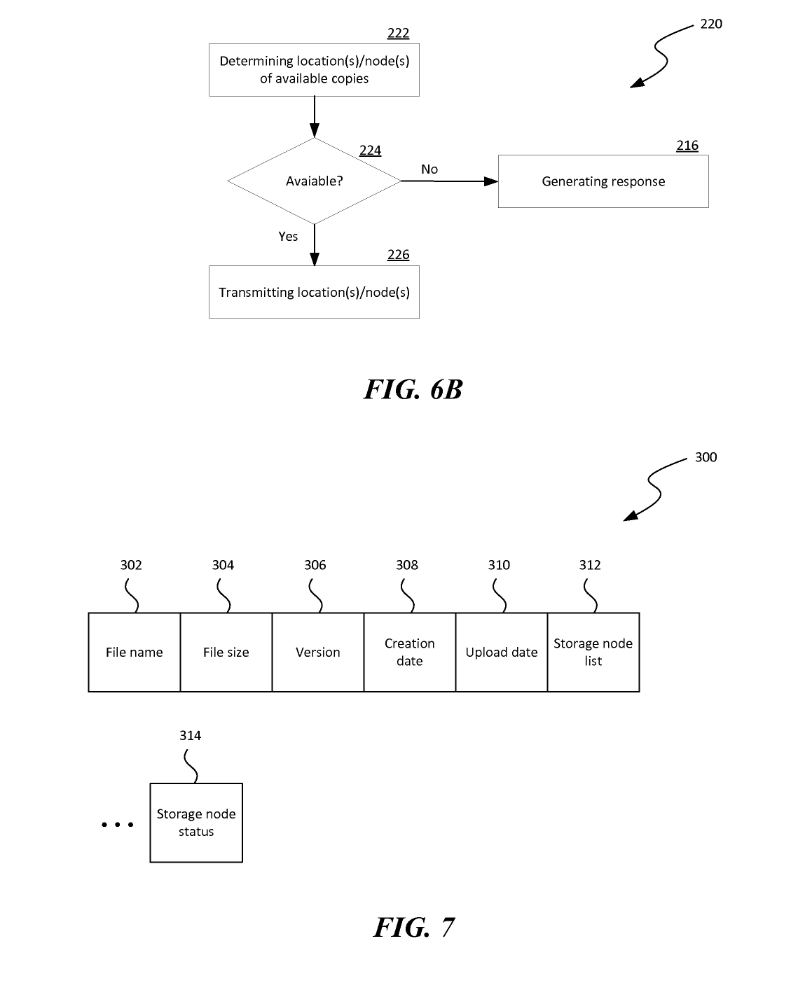

FIG. 7 is an example data schema 300 suitable for the image metadata 114 of FIG. 1 in accordance with embodiments of the disclosed technology. As shown in FIG. 7, the data schema 300 can include a file name field 302, a file size field 304, a version field 306, a creation date field 308, a upload date field 310, a storage node list field 312, and a storage node status field 314. Even though particular fields are illustrated in FIG. 7, in other embodiments, the data schema 300 can include additional, less, and/or different fields.

The file name field 302 can contain, for example, a text string representing a file name associated with an application image. The file size field can contain an integer, floating point, or other suitable types of value representing a file size associated with the application image. The version field 306 can contain, for example, an integer, decimal, or other suitable version value representing a version associated with an application image. In one embodiment, the version value may be assigned by the primary node 104 (FIG. 1). In other embodiments, the version value may be assigned by the user 101 (FIG. 1) via the client device 102 (FIG. 1).

The creation date field 308 can contain, for example, a date, time, or other suitable values representing a date or time at which the application image was created. The upload date field 310 can contain, for example, a date, time, or other suitable values representing a date or time at which the application image is received from the client device 102. The storage node list field 312 can contain a list of node IDs associated with nodes 105 (FIG. 1) at which a copy of the application image is stored. For example, In the illustrated embodiment of FIG. 1, the storage node list field 312 can contain node IDs associated with the primary node 104, the first secondary node 106a, and the second secondary node 106b. The storage node status field 314 can contain data indicating a current status of the nodes 105 associated with the list of node IDs in the storage node list field 312. For example, in one embodiment, the data in the storage node status field 314 can indicate whether a particular node 105 is online, offline, powering up, powering down, and/or other suitable status values.

FIG. 8 is a computing device 800 suitable for certain components of the computing framework 100 in FIGS. 1-4. For example, the computing device 800 may be suitable for the client device 102, the primary node 104, or one of the secondary nodes 106a-106d of FIGS. 1-4. In a very basic configuration 802, computing device 800 typically includes one or more processors 804 and a system memory 806. A memory bus 808 may be used for communicating between processor 804 and system memory 806.

Depending on the desired configuration, the processor 804 may be of any type including but not limited to a microprocessor (pP), a microcontroller (pC), a digital signal processor (DSP), or any combination thereof. The processor 804 may include one more levels of caching, such as a level one cache 810 and a level two cache 812, a processor core 814, and registers 816. An example processor core 814 may include an arithmetic logic unit (ALU), a floating point unit (FPU), a digital signal processing core (DSP Core), or any combination thereof. An example memory controller 818 may also be used with processor 804, or in some implementations memory controller 818 may be an internal part of processor 804.

Depending on the desired configuration, the system memory 806 may be of any type including but not limited to volatile memory (such as RAM), non-volatile memory (such as ROM, flash memory, etc.) or any combination thereof. The system memory 806 may include an operating system 820, one or more applications 822, and program data 824. The program data 824 may include, for example, the application image 112 and the image metadata 114. This described basic configuration 802 is illustrated in FIG. 8 by those components within the inner dashed line.

The computing device 800 may have additional features or functionality, and additional interfaces to facilitate communications between basic configuration 802 and any other devices and interfaces. For example, a bus/interface controller 830 may be used to facilitate communications between the basic configuration 802 and one or more data storage devices 832 via a storage interface bus 834. The data storage devices 832 may be removable storage devices 836, non-removable storage devices 838, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 806, removable storage devices 836, and non-removable storage devices 838 are examples of computer readable storage media. Computer readable storage media include storage hardware or device(s), examples of which include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which may be used to store the desired information and which may be accessed by computing device 800. Any such computer readable storage media may be a part of computing device 800. The term “computer readable storage medium” excludes propagated signals and communication media.

The computing device 800 may also include an interface bus 840 for facilitating communication from various interface devices (e.g., output devices 842, peripheral interfaces 844, and communication devices 846) to the basic configuration 802 via bus/interface controller 830. Example output devices 842 include a graphics processing unit 848 and an audio processing unit 850, which may be configured to communicate to various external devices such as a display or speakers via one or more A/V ports 852. Example peripheral interfaces 844 include a serial interface controller 854 or a parallel interface controller 856, which may be configured to communicate with external devices such as input devices (e.g., keyboard, mouse, pen, voice input device, touch input device, etc.) or other peripheral devices (e.g., printer, scanner, etc.) via one or more I/O ports 858. An example communication device 846 includes a network controller 860, which may be arranged to facilitate communications with one or more other computing devices 862 over a network communication link via one or more communication ports 864.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 800 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 800 may also be implemented as a personal computer including both laptop computer and non-laptop computer configurations.

Specific embodiments of the technology have been described above for purposes of illustration. However, various modifications may be made without deviating from the foregoing disclosure. In addition, many of the elements of one embodiment may be combined with other embodiments in addition to or in lieu of the elements of the other embodiments. Accordingly, the technology is not limited except as by the appended claims.

I/We claim:

1. A computing device having a processor, the computing device comprising:
a component configured to receive and store a copy of a software application;
a component configured to select one or more additional computing devices to store additional copies of the received software application, the one or more additional computing devices being interconnected to the computing device via a communications network;
a component configured to transmit a copy of the received software application to each of the selected one or more additional computing devices to be stored at the selected one or more additional computing devices; and
a component configured to record a location of the selected one or more additional computing devices at which one of the additional copies is stored, and wherein the computing device and each of the selected one or more additional computing devices individually include a component configured to execute the software application.

2. The computing device of claim 1, further comprising:
a computer readable storage medium operatively coupled to the processor; and
a component configured to store the received copy of the software application in the computer readable storage medium.

3. The computing device of claim 1, further comprising:
a computer readable storage medium operatively coupled to the processor;
wherein the component configured to record the location includes a component configured to generate metadata associated with the received copy of the software application, the metadata identifying the selected one or more additional computing devices at which a copy of the software application is stored; and
wherein the computing device further includes a component configured to store the generated metadata in the computer readable storage medium.

4. The computing device of claim 1 wherein:
the component configured to record the location includes a component configured to generate metadata associated with the received copy of the software application, the metadata identifying the selected one or more additional computing devices at which a copy of the software application is stored; and
the computing device further includes a component configured to transmit the generated metadata to the selected one or more additional computing devices.

5. The computing device of claim 1 wherein:
the component configured to record the location includes a component configured to generate metadata associated with the received copy of the software application, the metadata identifying the selected one or more additional computing devices at which a copy of the software application is stored; and
the computing device further includes:
a component configured to transmit the generated metadata to the selected one or more additional computing devices;
a component configured to receive one or more requests for file transfer from the selected one or more additional computing devices; and
wherein the component configured to transmit the copy is configured to transmit a copy of the received software application to each of the selected one or more additional computing devices in response to the received one or more requests.

6. The computing device of claim 1, further comprising:
a component configured to receive a confirmation from the individual selected one or more additional computing devices, the confirmation indicating that a copy of the software application is stored on the individual selected one or more additional computing devices; and
a component configured to generate a response indicating completion of storing the software application in response to a percentage or number of confirmations received exceeding a corresponding threshold.

7. The computing device of claim 1 wherein the computing device and the one or more additional computing devices are organized as a computing fabric, and wherein the computing device further includes:
a component configured to receive a confirmation from the individual selected one or more additional computing devices, the confirmation indicating that a copy of the software application is stored on the individual selected one or more additional computing devices; and
a component configured to generate a response indicating completion of storing the software application in response to a number of received confirmations exceeds 50% of a total number of the computing devices in the computing fabric.

8. The computing device of claim 1, further comprising:
a computer readable storage medium operatively coupled to the processor;
a component configured to store the received copy of the software application in the computer readable storage medium; and
wherein the copy of the software application stored in the computer readable storage medium is identical to each of the copies stored on the selected one or more additional computing devices.

9. The computing device of claim 1, further comprising:
a component configured to divide the received copy of the software application into a first portion and a second portion; and
the component configured to transmit the copy is configured to transmit a copy of at least one of the first portion or the second portion of the received software application to each of the selected one or more additional computing devices to be stored at the selected one or more additional computing devices.

10. A computing device interconnected to a plurality of other computing devices by a communications network to form a computing fabric, the computing device having a processor and comprising:
a component configured to receive a request from a requestor for a copy of a software application stored in the computing fabric, the computing fabric having one or more copies of the requested software application stored at one or more of the computing devices individually configured to execute the software application;
a component configured to determine the one or more computing devices in the computing fabric individually storing a copy of the requested software application based on recorded information regarding which one or more of the computing devices in the computing fabric store a copy of the requested software application; and
a component configured to inform the requestor of the determined one or more computing devices from which a copy of the requested user software stored is available for retrieval.

11. The computing device of claim 10 wherein the component configured to determine the one or more computing devices is configured to determine the one or more computing devices based on a physical or logical proximity of the one or more computing devices to the requestor.

12. The computing device of claim 10 wherein the component configured to determine the one or more computing devices is configured to determine the one or more computing devices based on a current traffic condition in the communications network of the computing fabric.

13. The computing device of claim 10, further comprising:
a computer readable storage medium operatively coupled to the processor, the computer readable storage medium storing a copy of the software application;
wherein the component configured to determine the computing device is configured to determine that a copy of the software application is available from the computer readable storage medium; and
the computing device further includes a component configured to transmit a copy of the stored software application to the requestor.

14. The computing device of claim 10 wherein:
the component configured to determine the one or more computing devices is configured to determine that a copy of a first portion of the software application is available from a first computing device and a second portion of the software application is available from a second computing device of the computing fabric; and
the component configured to inform is configured to inform the requestor of the determined first and second computing devices from which a copy of the first and second portions of the requested software application are available for retrieval, respectively.

15. The computing device of claim 10, further comprising:
a component configured to retrieve metadata associated with the requested copy of the software application, the metadata identifying one or more additional computing devices at which a copy of the software application is stored; and
the component configured to determine the one or more computing devices is configured to determine the one or more computing devices of the computing fabric that has a copy of the requested software application available for retrieval based on the retrieved metadata.

16. A method for distributed storage of digital data file in a computing fabric, the method comprising:
receiving a request to upload and store a software application at a computing fabric having a plurality of nodes interconnected by a communications network, the individual nodes of the computing fabric being configured to execute the software application;
receiving and storing a copy of the software application at one of the nodes of the computing fabric;
replicating, via the communications network, the copy of the software application received at the one of the nodes of the computing fabric as additional copies to be stored at one or more additional nodes of the computing fabric; and
generating and storing tracking information regarding which one or more of the nodes of the computing fabric individually contain a copy of the software application.

17. The method of claim 16, further comprising:
receiving, from a requestor, another request for a copy of the software application stored in the computing fabric;
in response to receiving the another request, determining which one or more of the nodes of the computing fabric contain a copy of the software application based on the stored tracking information; and
communicating the determined one or more nodes of the computing fabric containing a copy of the software application to the requestor.

18. The method of claim 16, further comprising:
receiving, from a requestor, another request for a copy of the software application stored in the computing fabric;
in response to receiving the another request, determining which one or more of the nodes of the computing fabric contain a copy of the software application based on the stored tracking information; and
transmitting a copy of the software application to the requestor from one of the determined one or more nodes of the computing fabric containing a copy of the software application.

19. The method of claim 16, further comprising:
receiving, from a requestor, another request for a copy of the software application stored in the computing fabric;
in response to receiving the another request, determining which one or more of the nodes of the computing fabric contain a copy of the software application based on the stored tracking information;
selecting a node from the determined one or more nodes of the computing fabric contain a copy of the software application based on at least one of a physical or logical proximity between the one or more nodes and the requestor; and
transmitting a copy of the software application to the requestor from the selected node.

20. The method of claim 16, further comprising:
receiving a request to delete the software application stored in the computing fabric;
in response to receiving the request to delete the software application, determining which one or more of the nodes of the computing fabric contain a copy of the software application based on the stored tracking information; and
transmitting a deletion instruction to each of the one or more nodes of the computing fabric containing a copy of the software application.
